(19) United States
(12) Patent Application Publication
(10) Pub. No.: US 2015/0280383 A1
(43) Pub. Date: Oct. 1, 2015

(54) Apparatus into Which Electronic Card May Be Inserted

(71) Applicants: Yinong Liu, Beijing (CN); Pi Lin, Beijing (CN); Chong Chen, Beijing (CN)

(72) Inventors: Yinong Liu, Beijing (CN); Pi Lin, Beijing (CN); Chong Chen, Beijing (CN)

(21) Appl. No.: 14/437,527

(22) PCT Filed: Oct. 22, 2012
(86) PCT No.: PCT/CN2012/083301

§ 371 Date: Apr. 22, 2015

(51) Int. Cl. H01R 29/00; G06K 7/00

(52) U.S. Cl. CPC H01R 29/00; G06K 7/0052

(57) ABSTRACT

An apparatus including a housing defining an interior cavity having a length, a width and a depth, at least one lateral constraint configured to constrain the width of the interior cavity when the apparatus is in a first configuration, and at least one longitudinal constraint configured to constrain the length of the interior cavity when the apparatus is in the first configuration, wherein, when the apparatus is in the first configuration, the cavity is configured for a first card, wherein, when the apparatus is in a second configuration, the interior cavity is configured for a second card, larger than the first card, and wherein insertion of the second card into the interior cavity causes depth-wise switching of the apparatus from the first configuration to the second configuration including retraction of at least one of the at least one lateral constraint and the at least one longitudinal constraint.

### TECHNOLOGICAL FIELD

Embodiments of the present invention relate to an apparatus into which an electronic card may be inserted.

### BACKGROUND

An electronic card may be used to augment the functionality of an electronic device. Different cards may be used to provide different functionality. For example, a memory card may be used to provide storage whereas a smart card may be used to provide additional processing capability.

### BRIEF SUMMARY

According to various, but not necessarily all, embodiments of the invention there is provided an apparatus comprising: a housing defining an interior cavity having a length, a width and a depth; at least one lateral constraint configured to constrain the width of the interior cavity when the apparatus is in a first configuration; and at least one longitudinal constraint configured to constrain the length of the interior cavity when the apparatus is in the first configuration; wherein, when the apparatus is in the first configuration, the cavity is configured for a first card, wherein, when the apparatus is in a second configuration, the interior cavity is configured for a second card, larger than the first card, and wherein insertion of the second card into the interior cavity causes switching of the apparatus from the first configuration to the second configuration comprising depth-wise retraction of at least one of the at least one lateral constraint and the at least one longitudinal constraint.

According to various, but not necessarily all, embodiments of the invention there is provided an apparatus comprising: a housing defining an interior cavity having a length, a width and a depth; at least one lateral constraint and at least one longitudinal constraint wherein the at least one lateral constraint and at least one longitudinal constraint are configured to position a first card when the first card is inserted in the interior cavity and configured to retract depth-wise when a second card, larger than the first card, is inserted in the interior cavity

According to various, but not necessarily all, embodiments of the invention there is provided an apparatus comprising: a housing defining an interior cavity having a length, a width and a depth; at least one lateral constraint configured to constrain the width of the interior cavity when the apparatus is in a first configuration; and at least one longitudinal constraint configured to constrain the length of the interior cavity when the apparatus is in the first configuration; wherein, when the apparatus is in the first configuration, the cavity is configured for a first card, wherein, when the apparatus is in a second configuration, the interior cavity is configured for a second card, larger than the first card and wherein insertion of the second card into the interior cavity causes switching of the apparatus from the first configuration to the second configuration comprising retraction of the at least one lateral constraint and the at least one longitudinal constraint, wherein the first longitudinal constraint is configured to retract in response to retraction of the first lateral constraint.

According to various, but not necessarily all, embodiments of the invention there is provided an apparatus comprising: a housing defining an interior cavity having a length, a width and a depth; at least one lateral constraint configured to constrain the width of the interior cavity when the apparatus is in a first configuration; and at least one longitudinal constraint configured to constrain the length of the interior cavity when the apparatus is in the first configuration; wherein, when the apparatus is in the first configuration, the cavity is configured for a first card, wherein, when the apparatus is in a second configuration, the interior cavity is configured for a second card, larger than the first card and wherein insertion of the second card into the interior cavity causes switching of the apparatus from the first configuration to the second configuration comprising retraction of the at least one lateral constraint and the at least one longitudinal constraint, wherein the housing defines a first aperture configured to receive the first card when inserted in a first direction and a second aperture configured to receive the second card inserted in a second direction opposite to the first direction.

### BRIEF DESCRIPTION

For a better understanding of various examples of embodiments of the present invention reference will now be made by way of example only to the accompanying drawings in which:

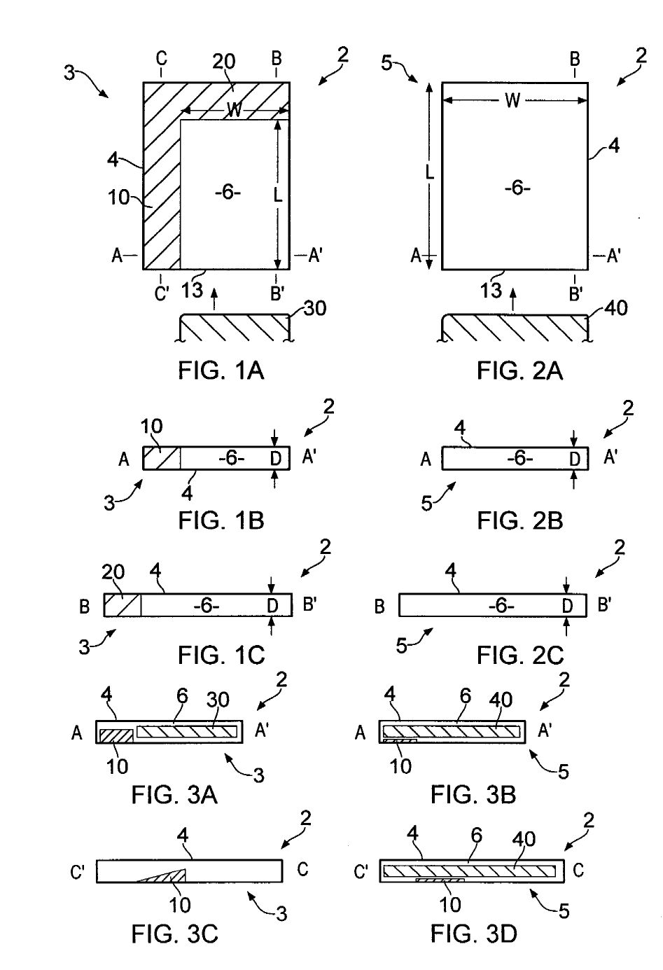

FIGS. 1A, 1B and 1C illustrate different cross-sectional views through an apparatus when it is in a first configuration;

FIGS. 2A, 2B and 2C illustrate different cross-sectional views through the apparatus when it is in a second configuration;

FIGS. 3A, 3B, 3C, 3D illustrate an example of a retractable lateral constraint;

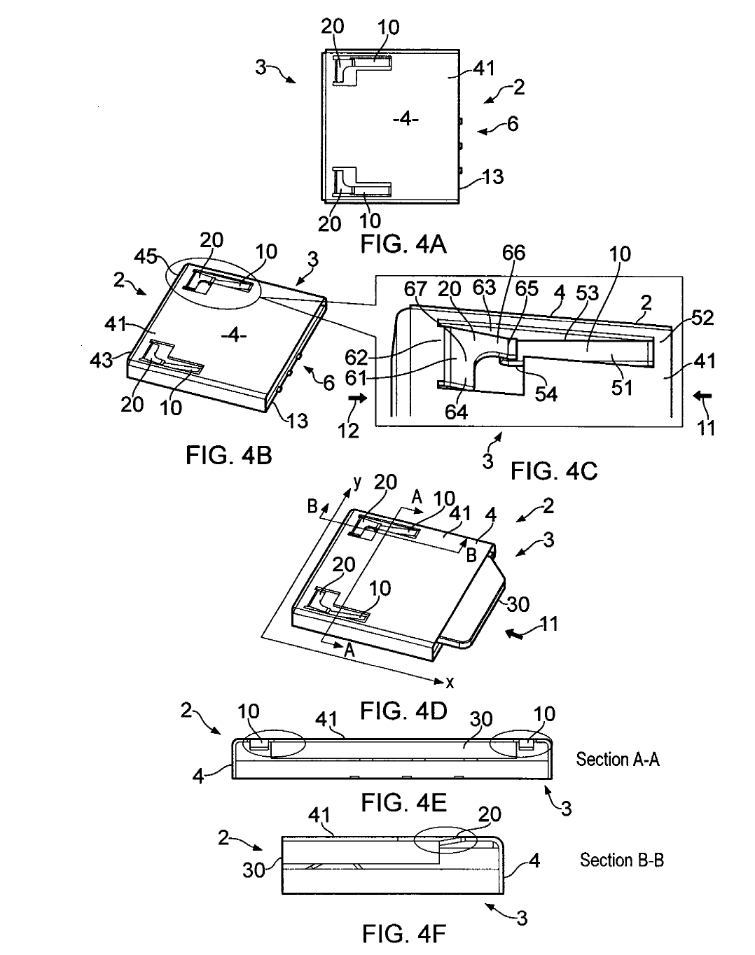

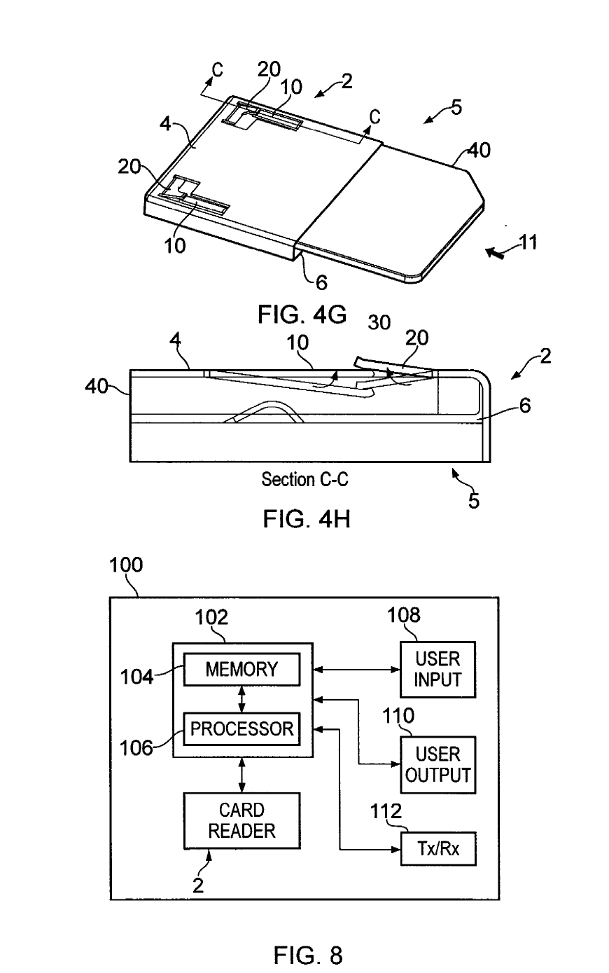

FIGS. 4A to 4H illustrate a first embodiment of the apparatus in which retraction of the lateral constraint causes retraction of the longitudinal constraint;

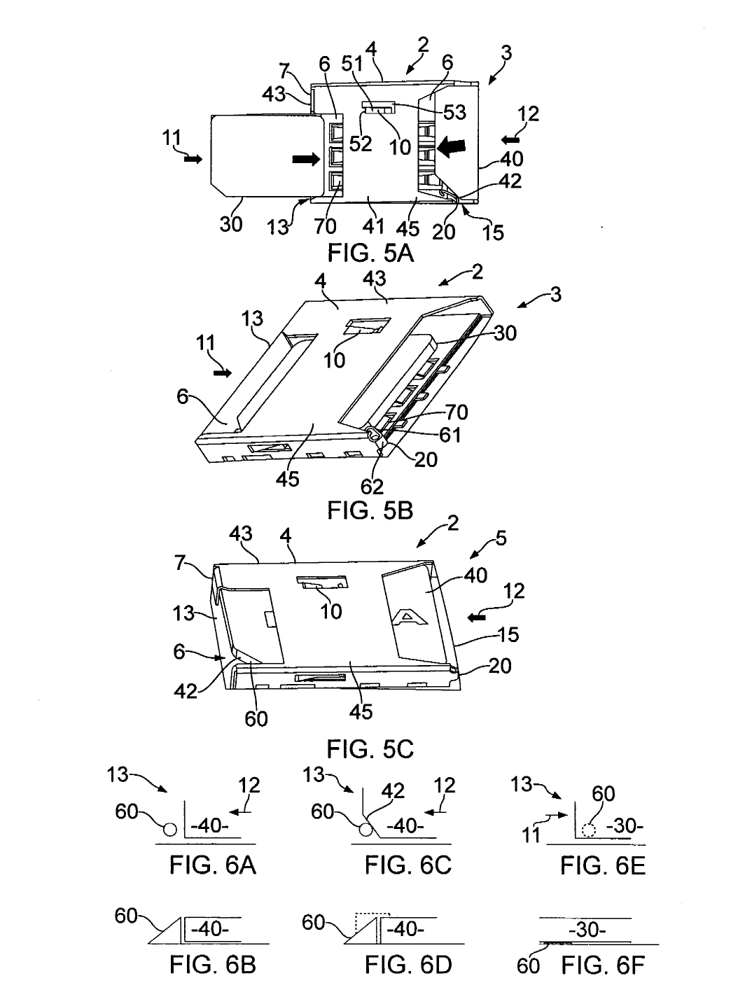

FIGS. 5A to 5C illustrate a second embodiment of the apparatus in which the lateral constraint and the longitudinal constraint are independent and one does not cause the retraction of the other;

FIGS. 6A-6F illustrate an additional longitudinal constraint which discourages incorrect insertion of the second card;

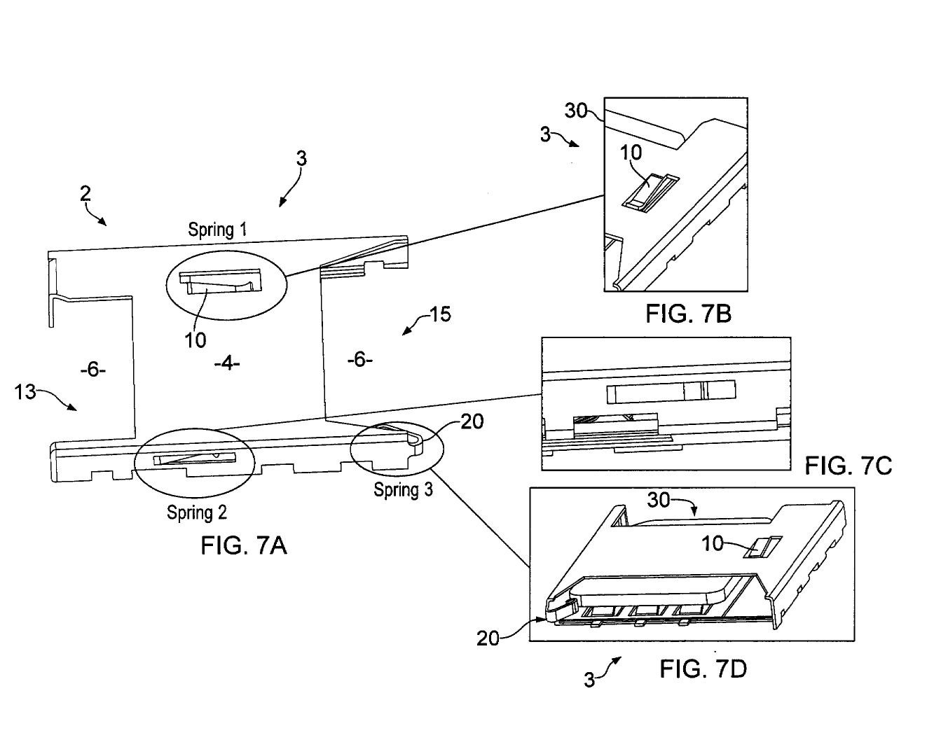

FIGS. 7A to 7D illustrate the apparatus illustrated in FIGS. 5A-5C without an inserted card; and

FIG. 8 illustrates an electronic device comprising a controller which is operatively coupled to a card reader apparatus.

### DETAILED DESCRIPTION

The Figures illustrate an example of an apparatus 2 comprising: a housing 4 defining an interior cavity 6 having a length L, a width W and a depth D; at least one lateral constraint 10 configured to constrain the width W of the interior cavity 6 when the apparatus 2 is in a first configuration 3; and at least one longitudinal constraint 20 configured to constrain the length L of the interior cavity 6 when the apparatus 2 is in the first configuration 3.

When the apparatus 2 is in the first configuration 3, the interior cavity 6 is configured for a first electronic card 30.

When the apparatus 2 is in a second configuration 5, the interior cavity 6 is configured for a second electronic card 40, larger than the first card 30.

Insertion of the second card 40 into the interior cavity 6 causes depth-wise retraction of the at least one lateral constraint 10 and/or the at least one longitudinal constraint 20 and switching of the apparatus 2 from the first configuration 3 to the second configuration 5.

Depth-wise retraction may for example comprise retraction towards a floor of the interior cavity or, alternatively, retraction towards a roof of the interior cavity.

FIGS. 1A, 1B and 1C illustrate different cross-sectional views through an apparatus 2 when it is in a first configuration 3. The cross-sectional plane of FIG. 1A is perpendicular to the depth-wise direction and parallel to the lateral and longitudinal directions. The cross-sectional plane of FIG. 1B is along the lateral section A-A′ illustrated in FIG. 1A. The cross-sectional plane of FIG. 1C is along the lateral section B-B′ illustrated in FIG. 1A.

FIGS. 2A, 2B and 2C illustrate different cross-sectional views through the same apparatus 2 when it is in a second configuration 5. The cross-sectional plane of FIG. 2A is perpendicular to the depth-wise direction and parallel to the lateral and longitudinal directions. The cross-sectional plane of FIG. 2B is along the lateral section A-A′ illustrated in FIG. 2A. The cross-sectional plane of FIG. 2C is along the lateral section B-B′ illustrated in FIG. 2A.

In FIGS. 1A-1C and 2A-2C, the apparatus 2 comprises a housing 4. The housing 4 defines an interior cavity 6. The cavity 6 has a length L in the longitudinal dimension, a width W in the lateral dimension and a depth D in the depth-wise dimension.

The housing 4 comprises an aperture to the interior cavity 6. In the first configuration, a first card 30 is inserted by a user through an aperture into the interior cavity 6. In the second configuration, a second card 30 is inserted by a user through an aperture into the interior cavity 6. In this example, but not necessarily all examples, a common aperture 13 is used for inserting/removing, at different times, the first card 30 and the second card 40. The second card is larger than the first card 30.

The housing 4 is sized to accommodate within the cavity 6 at any time either the first card 30 or the second card 40 but not both the first card 30 and the second card 40 at the same time.

In this example, but not necessarily all examples, the width W and the length L of the interior cavity 6 is different in the first configuration 3 and the second configuration 5.

When the apparatus 2 is in the second configuration 5 the interior cavity 6 may have a depth D, length L and width W that closely matches and snugly fits the dimensions of the second card 40 but not the first card 30.

When the apparatus 2 is in the first configuration 3 the interior cavity 6 may have a depth D, length L and width W that closes matches and snugly fits the dimensions of the first card 30 but not the second card 40.

The width W and the length L of the interior cavity 6 are constrained to be shorter in the first configuration 3 of the apparatus 2 than in the second configuration 5 of the apparatus 2.

In this example, but not necessarily all examples, a lateral constraint 10 is positioned within the housing 4 towards a lateral edge of the housing 4. The lateral constraint 10 is configured to constrain the width W of the interior cavity 6 when the apparatus 2 is in a first configuration 3 as illustrated in FIGS. 1A and 1B but not when the apparatus 2 is in the second configuration 5 as illustrated in FIGS. 2A and 2B.

In this example, but not necessarily all examples, a longitudinal constraint 20 is positioned within the housing 4 towards a longitudinal edge of the housing 4 that opposes the aperture 13. The longitudinal constraint 20 is configured to constrain the length L of the interior cavity 6 when the apparatus 2 is in a first configuration 3 as illustrated in FIGS. 1A and 1C but not when the apparatus 2 is in the second configuration 5 as illustrated in FIGS. 2A and 2C.

Insertion of a second card 40 into the interior cavity 6 through the aperture 13 switches the apparatus 2 from the first configuration 3 to the second configuration 5 by, for example, causing depth-wise retraction of the lateral constraint 10 and/or the longitudinal constraint 20 so that they no longer constrain the width W and length L of the interior cavity 6.

An example of a retractable lateral constraint 10 is illustrated in FIGS. 3A, 3B, 3C, 3D. FIGS. 3A and 3B illustrate a cross-section where the cross-sectional plane is along the lateral section A-A′ for the first configuration 3 (FIG. 3A) and the second configuration 5 (FIG. 3B). FIGS. 3A and 3B illustrate a cross-section where the cross-sectional plane is along the longitudinal section C-C′ for the first configuration 3 (FIG. 3C) and the second configuration 5 (FIG. 3D).

As illustrated in FIGS. 3A and 3C, when the apparatus 2 is in the first configuration 3, the lateral constraint 10 constrains the width W of the interior cavity 6 so that it is sized to snugly fit the first card 30.

The lateral constraint 10 is configured such that when a second card 40, which is wider than the first card 30, is inserted into the interior cavity 6, the second card 40 causes depth-wise retraction of the lateral constraint 10 so that it no longer constrains the width W of the interior cavity 6 (FIGS. 3B and 3D). This depth-wise retraction switches the configuration of the apparatus 2 from the first configuration 3 to the second configuration 5.

In the illustrated example, the lateral constraint 10 retracts depth-wise towards a floor of the housing 4. Alternatively, in other examples, the lateral constraint 10 may retract depth-wise towards a roof of the housing 4.

It will be appreciated that although FIGS. 3A-3D illustrate a lateral constraint 10 in transverse section for the first configuration (FIG. 3A), longitudinal section for the first configuration (FIG. 3C), transverse section for the second configuration (FIG. 3B) and longitudinal section for the second configuration (FIG. 3D), a similar arrangement may be provided for the longitudinal constraint 20 such that when a second card 40, which is wider than the first card 30, is inserted into the interior cavity 6, the second card 40 causes depth-wise retraction of the longitudinal constraint 20 so that it no longer constrains the length L of the interior cavity 6. This depth-wise retraction switches the configuration of the apparatus 2 from the first configuration 3 to the second configuration 5. The longitudinal constraint 20 may retract depth-wise towards a floor of the housing 4 or towards a roof of the housing 4.

The retractable lateral constraint 10 may be resiliently biased so that by default it extends or protrudes into the cavity 6 when the apparatus 2 is in the first (stable) configuration 3. The second card 40 retracts the lateral constraint 10 against this bias when the apparatus 2 is in the second (unstable) configuration 5.

The retractable longitudinal constraint 20 may be resiliently biased so that by default it extends or protrudes into the cavity 6 when the apparatus 2 is in the first (stable) configuration 3. The second card 40 retracts the longitudinal constraint 20 against this bias when the apparatus 2 is in the second (unstable) configuration 5.

In some examples, but not necessarily all examples, the lateral constraint 10 may comprise a cantilevered spring. A cantilevered spring is, a cantilever that, in its rest position, protrudes into the interior cavity 6. A cantilever is a member that is supported at one of four sides.

In some examples, but not necessarily all examples, the lateral constraint 10 may be an integral part of the housing 4 such that the lateral constraint 10 is formed as a part of the housing 4 as opposed to attached to the housing 4.

In some examples, but not necessarily all examples, the longitudinal constraint 20 may comprise a cantilevered spring. A cantilevered spring comprises a cantilever that, in its rest position, protrudes into the interior cavity 6. A cantilever may comprise a member that is supported at one of four sides.

In some examples, but not necessarily all examples, the longitudinal constraint 20 may be an integral part of the housing 4 such that the longitudinal constraint 20 is formed as a part of the housing as opposed to attached to the housing 4.

FIGS. 4A to 4H illustrate a first embodiment of the apparatus 2, for example as previously described, in which retraction of the lateral constraint 10 causes retraction of the longitudinal constraint 20.

FIG. 4A illustrates a plan view of the upper side (roof) 41 of the housing 4 of the apparatus 2. FIG. 4B illustrates a perspective view of the upper side (roof) 41 of the housing 4 of the apparatus 2 illustrated in FIG. 4A. FIG. 4C illustrates a more detailed view of the lateral constraint 10 and the longitudinal constraint 20 illustrated in FIG. 4B.

FIG. 4D illustrates a perspective view of the upper side 41 of the housing 4 of the apparatus 2 illustrated in FIG. 4A, when the apparatus 2 is in a first configuration 3 and the first card 30 is inserted. FIG. 4E illustrates a cross-sectional view along the cross-sectional plane defined by the section A-A in FIG. 4D. FIG. 4F illustrates a cross-sectional view along the cross-sectional plane defined by the section B-B in FIG. 4D.

FIG. 4G illustrates a perspective view of the upper side 41 of the housing 4 of the apparatus 2 illustrated in FIG. 4A, when the apparatus 2 is in a second configuration 5 and the second card 40 is inserted. FIG. 4H illustrates a cross-sectional view along the cross-sectional plane defined by the section C-C in FIG. 4G.

In the example of FIGS. 4A-4H, the housing 4 of the apparatus 2 defines an aperture 13 that is configured to receive the first card 30 when inserted in a first direction 11 and configured to receive the second card 40 when inserted in the same first direction 11.

In the example of FIGS. 4A-4H, a first lateral constraint 10 at a first side 43 of the cavity 6 is configured to constrain, at the first side 43, the width of the interior cavity 6 when the apparatus 2 is in the first configuration 3.

In this example, the first lateral constraint 10 is configured to retract depth-wise, into an upper side (roof) 41 of the housing 4 when abutted by the second card 40 on insertion of the second card 40. The first lateral constraint 10 is biased to protrude depth-wise, from the upper side 41 of the housing 4 into the interior cavity 6 at the first side 43 when the second card 40 is removed.

In the example of FIGS. 4A-4H, a second lateral constraint 10 at a second side 45 of the cavity 6, opposing laterally the first side 43 of the cavity 6, is configured to constrain, at the second side 45, the width of the interior cavity 6 when the apparatus 2 is in the first configuration 3.

The second lateral constraint 10 is configured to retract depth-wise, into an upper side (roof) 41 of the housing 4 when abutted by the second card 40 on insertion of the second card 40. The second lateral constraint 10 is biased to protrude depth-wise, from the upper side 41 of the housing 4 into the interior cavity 6 at the second side 45 when the second card 40 is removed.

In the example of FIGS. 4A-4H, a first longitudinal constraint 20 at the first side 43 of the cavity 6 is configured to constrain, at the first side 43, the length of the interior cavity 6 when the apparatus 2 is in a first configuration 3. The first longitudinal constraint 20 is configured to retract depth-wise, into the upper side (roof) 41 of the housing 4, at the first side 43, in response to the depth-wise retraction of the first lateral constraint 10 when the second card 40 is inserted.

The first lateral constraint 10 is configured to abut the first longitudinal constraint 20 and retraction of the first lateral constraint 10 towards the upper side (roof) 41 of the housing 4 forces retraction of the first longitudinal constraint 20. The first longitudinal constraint 20 may be biased to protrude depth-wise, from the upper side 41, into the interior cavity 6, when the second card 40 is removed and the first lateral constraint is no longer retracted and no longer forces the first longitudinal constraint 20 to retract.

In the example of FIGS. 4A-4H, a second longitudinal constraint 20 at the second side 45 of the cavity 6 is configured to constrain, at the second side 45, the length of the interior cavity 6 when the apparatus 2 is in a first configuration 3. The second longitudinal constraint 20 is configured to retract depth-wise, into the upper side (roof) 41 of the housing 4, at the second side 45, in response to the depth-wise retraction of the second lateral constraint 10 when the second card 40 is inserted.

The second lateral constraint 10 is configured to abut the second longitudinal constraint 20 and retraction of the second lateral constraint 10 towards the upper side (roof) 41 of the housing 4 forces retraction of the second longitudinal constraint 20. The second longitudinal constraint 20 may be biased to protrude depth-wise, from the upper side 41, into the interior cavity 6, when the second card 40 is removed and the second lateral constraint 10 is no longer retracted and no longer forces the second longitudinal constraint 20 to retract.

Referring in particular to FIG. 4C, the figure illustrates one example implementation of a co-operating pair of constraints including the lateral constraint 10 and the longitudinal constraint 20.

The lateral constraint 10 comprises a lateral member 51 that extends longitudinally in the first direction 11 (the direction of insertion of a card) from a connection point 52 to the housing 4 at one end of the lateral member 51. The lateral member 51 is otherwise free-standing in this example and is otherwise unconnected with the housing 4. The lateral member 51, in its rest state, makes a shallow (<45°) acute angle with the upper side 41 of the housing from the connection point 52 and protrudes, at that angle, into the cavity 6 from the upper side 41 of the housing, suspended from the connection point 52. The lateral member 51 thus forms a cantilever. The lateral member 51 is configured to pivot about the connection point 52 when the second card 40 is inserted and retract away from the cavity 6 into an aperture or receptacle 53 in the upper surface (roof) 41 of the housing 4.

As illustrated in FIGS. 4D and 4E, the inside lateral edge 54 of the lateral member 51 provides a restraining surface that restrains the lateral dimension of the cavity 6 and controls a position of the first card 30 in the cavity 6 when the first card 30 is inserted (first configuration). As illustrated in FIGS. 4G and 4H, the lateral member 51 is retracted and does not provide a restraining surface that restrains the lateral dimension of the cavity 6 when the second card 40 is inserted (second configuration).

In FIG. 4C, the longitudinal constraint 20 comprises a longitudinal member 61 that extends longitudinally in a second direction 12 (opposite the first direction 11 and opposite the direction of insertion of a card) from a connection point 62 to the housing 4 at one end of the longitudinal member 61.

The longitudinal member 61 is otherwise free-standing in this example and is otherwise unconnected with the housing 4. The longitudinal member 61, in its rest state, makes a shallow (<45°) acute angle with the upper side 41 of the housing 4 from the connection point 62 and protrudes, at that angle, into the cavity 6 from the upper side 41 of the housing, suspended from the connection point 62. The longitudinal member 61 thus forms a cantilever. The longitudinal member 61 is configured to pivot about the connection point 62 when the second card 40 is inserted and retract away from the cavity 6 into an aperture or receptacle 63 in the upper surface (roof) 41 of the housing 4.

In this example, the longitudinal member 61 is rigid. It comprises a longitudinal part 64 that extends laterally and a lateral part 65 that extends longitudinally. The longitudinal part 64 and the lateral part 65 have a fixed relationship and do not move relative to each other. The lateral part 65 is used as an actuator to move the longitudinal part 64

The lateral part 65 overlaps and overlies the lateral member 51 of the lateral constraint 10. On insertion of the second card 40, the lateral member 51 of the lateral constraint 10 rotates about the pivot point 52 and retracts towards the upper side 41 of the housing 4 away from the cavity 6. The lateral member 51 of the lateral constraint 10 abuts the overlying and overlapping lateral part 65 of the longitudinal member 61 of the longitudinal constraint 20, and as it retracts from the cavity 6, it forces the longitudinal constraint 20 including the longitudinal part 64 and the lateral part 65 of the longitudinal member 61 to retract away from the cavity 6 into the aperture or receptacle 63 in the upper surface (roof) 41 of the housing 4.

As illustrated in FIG. 4D, an inside lateral edge 66 of the lateral part 65 of the longitudinal member 61 may provide a restraining surface that restrains the lateral dimension of the cavity 6 and controls a position of the first card 30 in the cavity 6 when the first card 30 is inserted (first configuration). As illustrated in FIGS. 4G and 4H, the longitudinal member 61 is retracted and does not provide a restraining surface that restrains the lateral dimension of the cavity 6 when the second card 40 is inserted (second configuration).

As illustrated in FIGS. 4D and 4F, an inside longitudinal edge 67 of the longitudinal part 64 of the longitudinal member 61 provides a restraining surface that restrains the longitudinal dimension of the cavity 6 and controls a position of the first card 30 in the cavity 6 when the first card 30 is inserted (first configuration). As illustrated in FIGS. 4G and 4H, the longitudinal member 61 is retracted and does not provide a restraining surface that restrains the longitudinal dimension of the cavity 6 when the second card 40 is inserted (second configuration).

FIGS. 5A to 5C illustrate a second embodiment of the apparatus 2, as previously described, in which the lateral constraint 10 and the longitudinal constraint 20 are independent and one does not cause the retraction of the other.

FIG. 5A illustrates a plan view of the upper side (roof) 41 of the housing 4 of the apparatus 2. FIG. 5B illustrates a perspective view of the upper side 41 of the housing 4 of the apparatus 2 illustrated in FIG. 5A, when the apparatus 2 is in a first configuration 3 and the first card 30 is inserted. FIG. 5C illustrates a perspective view of the upper side 41 of the housing 4 of the apparatus 2 illustrated in FIG. 5A, when the apparatus 2 is in a second configuration 5 and the second card 40 is inserted.

In the example of FIGS. 5A-5C, the housing 4 of the apparatus 2 defines a first aperture 13 that is configured to receive the first card 30 when inserted in a first direction 11 and comprises a second aperture 15 that is configured to receive the second card 40 when inserted in the second direction 12 that is opposite the first direction. The first aperture 13 and the second aperture 15 oppose each other at opposite longitudinal ends of the housing 4.

The first aperture 13 has a width that is narrower than the second aperture 15. The width of the first aperture is greater than a width of the first card 30 but less than a width of the second card 40.

A portion 7 of the housing 4 adjacent the first aperture 13 defines the width of the first aperture 13 and provides a longitudinal stop for the second card 40 when inserted.

In the example of FIGS. 5A-5C, a lateral constraint 10 at a first side 43 of the cavity 6 is configured to constrain, at the first side 43, the width of the interior cavity 6 when the apparatus 2 is in the first configuration 3.

In this example, the lateral constraint 10 is configured to retract depth-wise, into an upper side (roof) 41 of the housing 4 when abutted by the second card 40 on insertion of the second card 40 through the second aperture 15. The lateral constraint 10 is biased to protrude depth-wise, from the upper side 41 of the housing 4 into the interior cavity 6 at the first side 43 when the second card 40 is removed.

In this particular example (other examples are possible), the lateral constraint 10 comprises a lateral member 51 that extends longitudinally in the first direction 11 (the direction of insertion of the first card 30) from a connection point 52 to the housing 4 at one end of the lateral member 51. In an alternative embodiment the lateral member 51 extends longitudinally in the second direction 12 (the direction of insertion of the second card 40). The lateral member 51 is otherwise free-standing in this example and is otherwise unconnected with the housing 4. The lateral member 51, in its rest state, makes a shallow (<45°) acute angle with the upper side 41 of the housing from the connection point 52 and protrudes, at that angle, into the cavity 6 from the upper side 41 of the housing, suspended from the connection point 52. The lateral member 51 thus forms a cantilever. The lateral member 51 is configured to pivot about the connection point 52 when the second card 40 is inserted and retract away from the cavity 6 into an aperture or receptacle 53 in the upper surface (roof) 41 of the housing 4.

The inside lateral edge of the lateral member 51 provides a restraining surface that restrains the lateral dimension of the cavity 6 and controls a position of the first card 30 in the cavity 6 when the first card 30 is inserted (first configuration). The lateral member 51, when retracted, does not provide a restraining surface that restrains the lateral dimension of the cavity 6 when the second card 40 is inserted (second configuration).

In the example of FIGS. 5A-5C, a longitudinal constraint 20 at the second side 45 of the cavity 6 is configured to constrain, at the second side 45, the length of the interior cavity 6 when the apparatus 2 is in a first configuration 3. The longitudinal constraint 20 is configured to retract width-wise, into the sidewall of the housing 4, when abutted by the second card 40 on insertion of the second card 40 through the second aperture 15 in the second direction 12.

The longitudinal constraint 20 may be positioned adjacent the second aperture 15 such that the lateral separation distance between the lateral constraint 10 and the longitudinal constraint 20 is less than a width of the first card 30. This will discourage insertion of the first card 30 into the second aperture 15.

In this particular example (other examples are possible), the longitudinal constraint 20 comprises a longitudinal member 61 that extends longitudinally in a second direction 12 (opposite the first direction 11) from a connection point 62 to the housing 4 at one end of the longitudinal member 61. The longitudinal member 61 is otherwise free-standing in this example and is otherwise unconnected with the housing 4. The longitudinal member 61, in its rest state, makes a shallow (<45°) acute angle with the sidewall of the housing 4 from the connection point 62 and protrudes, at that angle, into the cavity 6 from the sidewall of the housing, suspended from the connection point 62. The longitudinal member 61 thus forms a cantilever. The longitudinal member 61 is configured to pivot about the connection point 62 when the second card 40 is inserted and retract away from the cavity 6 towards the sidewall from which it depends.

Although in this embodiment, the longitudinal member 61 depends from a sidewall and retracts laterally towards the sidewall, in other examples, the longitudinal member 61 may depend from a roof (or floor) of the housing and retract depth-wise.

In the illustrated example, a chamfer 42 of the second card 40 abuts the longitudinal member 61 when the second card 40 is correctly inserted. The longitudinal member 61 is configured so that it is easily retracted by a chamfered corner of the second card 40 inserted in the second direction 12 but less easily retracted by an un-chamfered corner of the second card 40 inserted in the second direction 12. A chamfer or chamfered corner is an oblique surface formed by, for example, cutting-off a corner of a rectangle, perhaps at 45°.

It will be appreciated that the lateral constraint 10 and the longitudinal constraint 20 are configured to retract when abutted by different parts of a second card 40.

The chamfer 42 of the second card 40, when correctly positioned, results in an area adjacent the first aperture 13 being unoccupied by the second card 40 when it is correctly inserted. This area may be occupied by an additional longitudinal constraint 60, as illustrated in FIGS. 5C and 6A-6F which discourages incorrect insertion of the second card 40.

As illustrated in plan view in FIG. 6A and side view in FIG. 6B, when a second card 40 is incorrectly orientated and inserted through the second aperture 15 an un-chamfered corner of the second card 40 abuts the additional longitudinal constraint 60 preventing full insertion of the second card 40 into the cavity 6.

As illustrated in plan view in FIG. 6C and side view in FIG. 6D, when a second card 40 is correctly orientated and inserted through the second aperture 15 a chamfer 42 62 of the second card 40 abuts or approaches the additional longitudinal constraint 60 enabling full insertion of the second card 40 into the cavity 6.

As illustrated in plan view in FIG. 6E and side view in FIG. 6F, when a first card is inserted through the first aperture 13, the first card 30 abuts the additional longitudinal constraint 60 and causes it to retract enabling full insertion of the first card 30 into the cavity 6.

The additional longitudinal constraint 60 positioned adjacent the first aperture 13 is retractable on insertion of first card 30 but not retractable on insertion of second card 40.

FIG. 7A illustrates the apparatus 2 illustrated in FIGS. 5A-5C without an inserted card. FIGS. 7B, 7C, 7D illustrate respectively in closer detail, the lateral constraint 10, a sidewall spring member used to grip an inserted card, and the longitudinal constraint 20.

The apparatus 2 described in the preceding examples may be a card reader or a housing for a card reader. A card reader comprises a plurality of electrical contacts that are positioned to match corresponding contacts of a correctly inserted card.

A common set of electrical contacts may be used to connect with the contacts of the correctly inserted first card 30 and the correctly inserted second card 40.

It should be appreciated that the apparatus 2 may receive, at different times (not simultaneously) the first card 30 or the second card 40 and that the smaller first card 30 can be directly inserted into the apparatus 2 without the need to first insert the first card 30 into an adaptor or cradle. Thus the insertion of a card in the above described examples may comprise direct insertion, that is, insertion of the card directly into the apparatus 2 without any intermediate carrier, adaptor etc.

The apparatus 2 may be configured to only receive the first card 30 and the second card 40. Alternatively the apparatus 2 may be configured to receive the first card 30 and the second card 40 and one or more additional cards.

The first electronic card 30 may be an electronic device shaped as a card or carried on a card shaped substrate. A card is substantially planar. The first card 30 may perform one or more functions. For example, the first card 30 may be a memory card that comprises a memory, it may be a smart card that comprises processing circuitry, it may be a telecommunications card that enables telecommunications, it may be a security card that enables authentication, it may be a security card that enables encryption, it may be a security card that enables financial transactions, it may comprise a secure memory and a secure processor.

The second card 40 may be an electronic device shaped as a card or carried on a card shaped substrate. A card is substantially planar. The second card 40 may perform one or more functions. For example, the second card 40 may be a memory card that comprises a memory, it may be a smart card that comprises processing circuitry, it may be a telecommunications card that enables telecommunications, it may be a security card that enables authentication, it may be a security card that enables encryption, it may be a security card that enables financial transactions, it may comprise a secure memory and a secure processor.

The second card 40 may be wider and longer that the first card 30.

The second card 40 and the first card 30 may, for example, be cards such as, for example,

an ISO 7816 card such as:

ID-1 having dimensions 54 mm×85.6 mm

Visa Mini having dimensions 40 mm×66 mm

10-00 having dimensions 33 mm×66 mm

ID-000 [Subscriber Identity Module (SIM)] having dimension 15 mm×25 mm×0.76 mm

Mini-UICC [Micro SIM] having dimensions 12 mm×15 mm×0.76 mm

ETSI TS 102 221 [Nano-SIM] having dimensions 8.8 mm×12.3 mm×0.67 mm.

It is expected that the apparatus 2 may be configured for use with any two or more of the second form factor (2FF) SIM (15 mm×25 mm); the 3FF SIM (12 mm×15 mm); the 4FF SIM (8.8 mm×12.3 mm×0.67 mm) or a later generation SIM.

FIG. 8 illustrates an electronic device 100 comprising a controller 102 which is operatively coupled to a card reader apparatus 2 as described in one of the preceding examples. The controller 102 is configured to use functionality provided by a card inserted in the card reader 2.

The controller 102 may comprise a processor 106 and a memory 104. The processor 106 may be configured to read from and write to the memory 104.

The controller 102 is also configured to receive input commands from the user input 108, provide output to the user output 110.

Optionally, the electronic device may comprise a radio transmitter and/or receiver 112. This may, in some but not necessarily all embodiments, be a cellular radio telephone transceiver.

In some embodiments, but not necessarily all embodiments, the electronic device 100 may be a hand-portable electronic device which is sized to be carried in the palm of the hand or an inside jacket pocket.

In some embodiments, but not necessarily all embodiments, the electronic device 100 may be a terminal device in a cellular radio telephone network. A card inserted in the card reader apparatus 2 may be used, for example, to authenticate a user in the network and/or create an encryption key for encryption and/or decrypting data communicated in the network.

Some embodiments of the invention provide a mechanically simple, low volume and reduced size multi-card reader.

As used here ‘module’ refers to a unit or apparatus that excludes certain parts/components that would be added by an end manufacturer or a user. The apparatus 2 may, in some examples, be a module.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
a housing defining an interior cavity having a length, a width and a depth; at least one lateral constraint configured to constrain the width of the interior cavity when the apparatus is in a first configuration; and
at least one longitudinal constraint configured to constrain the length of the interior cavity when the apparatus is in the first configuration;
wherein, when the apparatus is in the first configuration, the cavity is configured for a first card,
wherein, when the apparatus is in a second configuration, the interior cavity is configured for a second card, larger than the first card, and
wherein insertion of the second card into the interior cavity causes switching of the apparatus from the first configuration to the second configuration comprising depth-wise retraction of at least one of the at least one lateral constraint and the at least one longitudinal constraint.

2. An apparatus as claimed in claim 1, wherein the at least one lateral constraint is configured to retract depth-wise from the interior cavity defined by the housing when the second card is inserted into the interior cavity and wherein the at least one lateral constraint is resiliently biased to protrude into the interior cavity.

3. (canceled)

4. (canceled)

5. (canceled)

6. An apparatus as claimed in claim 1, wherein the at least one longitudinal constraint is configured to retract depth-wise from the interior cavity defined by the housing when the second card is inserted into the interior cavity and wherein the at least one longitudinal constraint is resiliently biased to protrude into the interior cavity.

7. (canceled)

8. (canceled)

9. (canceled)

10. (canceled)

11. An apparatus as claimed in claim 1, comprising: a first lateral constraint at a first side of the interior cavity configured to constrain at the first side the width of the interior cavity when the apparatus is in a first configuration and a second lateral constraint at a second side of the interior cavity, opposing the first side of the interior cavity, configured to constrain at the second side the width of the interior cavity when the apparatus is in a first configuration.

12. An apparatus as claimed in claim 11, wherein the first lateral constraint is configured to retract depth-wise when abutted by a second card on insertion of the second card.

13. An apparatus as claimed in claim 11, wherein the second lateral constraint is configured to retract depth-wise when abutted by the second card on insertion of the second card.

14. An apparatus as claimed in claim 11, comprising a first longitudinal constraint at a first side of the interior cavity configured to constrain at the first side the length of the interior cavity when the apparatus is in a first configuration and a second longitudinal constraint at a second side of the interior cavity, opposing the first side of the interior cavity, configured to constrain at the second side the length of the interior cavity when the apparatus is in a first configuration.

15. An apparatus as claimed in claim 14, wherein the first longitudinal constraint is configured to retract depth-wise in response to depth-wise retraction of the first lateral constraint.

16. (canceled)

17. An apparatus as claimed in claim 14, wherein the second longitudinal constraint is configured to retract depth-wise in response to depth-wise retraction of the second lateral constraint.

18. (canceled)

19. An apparatus as claimed in claim 1, wherein the housing defines a first aperture configured to receive the first card when inserted in a first direction and a second aperture configured to receive the second card inserted in a second direction opposite to the first direction.

20. (canceled)

21. An apparatus as claimed in claim 19, wherein the at least one lateral constraint is configured to retract depth-wise when abutted by a second card on insertion of the second card.

22. An apparatus as claimed in claim 19, wherein the at least one longitudinal constraint is configured to retract when abutted by a second card.

23. (canceled)

24. An apparatus as claimed in claim 19, wherein the at least one lateral constraint and the at least one longitudinal constraint are configured to retract independently when abutted by different parts of a second card.

25. An apparatus as claimed in claim 19, wherein the at least one lateral constraint and the at least one longitudinal constraint are positioned adjacent the second aperture and wherein the lateral distance between them is less than a width of the first card.

26. An apparatus as claimed in claim 19, wherein the portion of the housing adjacent the first aperture defines a fixed longitudinal stop for the second card when inserted.

27. An apparatus as claimed in claim 1, further comprising an additional longitudinal constraint configured to retract on insertion of the first card but not retract on insertion of the second card and positioned at a position corresponding to a chamfer of the second card when the second card is correctly inserted.

28. An apparatus as claimed in claim 1, further comprising a common set of electrical contacts configured for contact with respective contacts of the first card and the second card.

29. (canceled)

30. An apparatus comprising:
a housing defining an interior cavity having a length, a width and a depth; at least one lateral constraint configured to constrain the width of the interior cavity when the apparatus is in a first configuration; and
at least one longitudinal constraint configured to constrain the length of the interior cavity when the apparatus is in the first configuration;
wherein, when the apparatus is in the first configuration, the cavity is configured for a first card,
wherein, when the apparatus is in a second configuration, the interior cavity is configured for a second card, larger than the first card and
wherein insertion of the second card into the interior cavity causes switching of the apparatus from the first configuration to the second configuration comprising retraction of the at least one lateral constraint and the at least one longitudinal constraint, wherein the first longitudinal constraint is configured to retract in response to retraction of the first lateral constraint.

31. An apparatus comprising:
a housing defining an interior cavity having a length, a width and a depth; at least one lateral constraint configured to constrain the width of the interior cavity when the apparatus is in a first configuration; and
at least one longitudinal constraint configured to constrain the length of the interior cavity when the apparatus is in the first configuration;
wherein, when the apparatus is in the first configuration, the cavity is configured for a first card,
wherein, when the apparatus is in a second configuration, the interior cavity is configured for a second card, larger than the first card and
wherein insertion of the second card into the interior cavity causes switching of the apparatus from the first configuration to the second configuration comprising retraction of the at least one lateral constraint and the at least one longitudinal constraint, wherein the housing defines a first aperture configured to receive the first card when inserted in a first direction and a second aperture configured to receive the second card inserted in a second direction opposite to the first direction.

32. An apparatus as claimed in claim 31, wherein the at least one lateral constraint and the at least one longitudinal constraint are positioned adjacent the second aperture and wherein the lateral distance between them is less than a width of the first card.

33. (canceled)

34. (canceled)

35. (canceled)
